(19) United States
(12) Patent Application Publication
(10) Pub. No.: US 2013/0049938 A1
(43) Pub. Date: Feb. 28, 2013

(54) Process of Preparing and Processing Sewing Data Transmitted Over a Wireless Network for an Automatic Sewing Machine

(71) Applicant: David Hooke, Lake Forest, IL (US)

(72) Inventor: David Hooke, Lake Forest, IL (US)

(21) Appl. No.: 13/593,712

(22) Filed: Aug. 24, 2012

Related U.S. Application Data
(60) Provisional application No. 61/526,981, filed on Aug. 24, 2011.

(51) Int. Cl. G08C 17/02

(52) U.S. Cl. 340/12.5

(57) ABSTRACT

The present invention relates generally to the field of a system and method of interaction between an end user and a sewing machine.

The sewing stitch patterns are transmitted to the mobile device through a wireless signal along with a user identification number to either a server or a wireless receiver module. The server uses the user identification number to look up the user's preferred Internet vendor and content provider. Once the preferences have been determined, this information is sent from the server to a wireless receiver module. The wireless receiver module will serve as a duel function as a receiver and transmitter of signals or send a signal directly to the wireless receiver module. The wireless receiver module transmits a control signal and controls the operation of a motor unit The wireless receiver module transmits a feedback wireless progress signal.

### FIELD OF THE INVENTION

The present invention relates generally to the field of systems capable of managing the interaction between an end user and sewing machine. More specifically, the present invention provides a method for end users utilizing mobile devices to wirelessly control a sewing machine.

### BACKGROUND OF THE INVENTION

When sewing, embroidering, or quilting it is desirable to control a sewing machine to stitch specifically to a pattern. The end user will stretch an article of cloth or the like into a frame. The frame can be moved in a horizontal level within certain limits. The end user will place the stitch-forming device underneath the article of cloth.

In a conventional sewing machine, an end user controls the motor through a pedal-type controller. The speed of the motor is controlled by the extent of treading action on the pedal.

When the conventional sewing machine motor is in use, the apparatus is generally placed on top of a table, and the end user is at or near the apparatus to control the sewing action of the motion. Therefore a signal is transmitted from a pedal to the sewing machine in the presence of the end user.

Alternatively, the article to be sewn can also be displaced step-wise in the two direction of the sewing plane, for example by means of a feeder inserted into a stitching plate. The machine control adjusts and/or controls the movements of the frame and/or the transportation device and the sewing needle depending on saved data, which represent the pre-determined pattern. The format of such data is generally equivalent to normal regulations and/or standards. This allows exchange of data concerning sewing, stitching, or embroidery patterns independent from the respective system platform. The databases can be created and or modified, e.g. in computers by means of suitable software, e.g. using an editor for embroidery patters. In order to create embroidery pattern databases according to samples, said samples can be scanned, e.g. and subsequently be further processed by a computer program.

In sewing machines that include a learning mode, samples can also be detected and saved directly during sewing, embroidering, or quilting.

Many systems currently exists which use control of a wireless pedal operated by an end user in controlling an internal motor unit of a conventional sewing machine. However, using such systems requires an end user to be at the same location as the sewing machine.

To overcome the aforesaid drawback, it is hereby proposed to use a mobile device to transmit a wireless transmission from a remote location. With the advent of mobile phones and other similar mobile devices, technology has developed to allow communication between a mobile device and a sewing machine. Therefore, mobile devices can now be utilized with systems which link a sewing machine to an end user while the end user is not located at or near the sewing machine.

### SUMMARY OF THE INVENTION

The present invention discloses a system and method for a mobile device which is used to manage a sewing machine from a remote location. The system utilizes a mobile device equipped with a wireless communication capabilities, a wireless network, a server having a plurality of different databases, (e.g. a user database and a vender database), and a plurality of content providers. The mobile device may be any device capable of transmitting data over the wireless network such as a cell phone, a camera phone, a personal digital assistant, etc.

Quilting patters are the templates for sewing with the present invention. It should be apparent to one skilled in the art the patterns can be two-dimensional. The sample patterns can be of any arbitrary type. For example, simple sewing patterns and/or seams on thin or thick material can serve as samples just as well as relatively thick, patted quilts or complex embroidery patters. Even prints on paper are suitable as samples. The term “sewing patterns” is to be understood in a general manner and comprises in particular contours and/or stitch sequences of embroideries or quilts and samples of sewing stitches. In the context of detecting the samples, the terms “article to be sewn” and “sample” are used synonymously.

The wireless network may be any network capable of transmitting information wirelessly between a mobile device and a computer and/or other mobile device. For example, the wireless network could be a cellular network, satellite network, Bluetooth network, Wi-Fi network, etc.

To use the system, a user first selects a pattern using the mobile device. The user may select a pattern using a program, or “application”, which allows a user to select, purchases, or otherwise elects a quilting pattern. If the user elects to purchase a pattern, the pattern may be transmitted from a vender wirelessly to the mobile device.

After the user selects a pattern, the patter information and the user identification number are sent to a server via a wireless network. The server then uses the transmitted user identification number to look up the user's pre-set signal controller. The signal is transmitted via the wireless network to the controller. The controller is placed at or near the sewing machine.

The sewing machine includes a main housing, a motor unit disposed in the main housing, a wireless receiver module mounted on the main housing, and a speed control module separate from the main housing and operable so as to enable wireless transmission of signals to the wireless receiver module in response to a treading action signal thereon.

The controller receives and then converts the wireless transmission to a new signal for the sewing machine. The new signal for the sewing machine is received by a wireless receiver module mounted on the main housing unit of the sewing machine. The signal contains an identification portion and command portion. The command portion can control the motor to commence, continue, stop, cancel, or the like the speed of the stitching.

A predetermined scaling factor is considered during the generation of the sewing or processing of the data for the purpose of creating sewing, stitching, or embroidering patterns on the article to be sewn, the samples detected can remain unchanged with respect to their dimensions or can be enlarged or reduced.

The wireless module after receiving the incoming signal verifies the identification code portion and command portion. After a match is detected, the motor functions in accordance with the command signal received by the wireless receiver module.

The wireless module can transmit a response signal to the controller. The controller receives and then converts the wireless transmission to a new signal as a feedback response to the mobile device. The controller then transmits a new signal containing a user identification number and feedback information via the wireless network to the mobile device user.

Therefore, it is an object of the present invention to provide a user a method to operate a sewing machine remotely utilizing a mobile device.

An additional object of the present invention is to provide a method for a user to transmit a signal from a mobile device at a remote location via a wireless communication medium including the Internet to a receiving unit located at or near a sewing machine to operate the sewing machine.

An additional object of the present invention is to provide a method for a user to receive a signal transmitted via a wireless communication medium including the internet on a mobile device at a remote location from a sewing machine connected to a controller.

An additional object of the present invention is to provide a method for a user to receive a signal on a mobile device at a remote location from a sewing machine.

An additional object of the present invention is to provide the ability to view information available on mobile devices which was previously not accessible.

An additional object of the present invention is to provide a method that has the possibility for mobile devices to function with many sewing machines and quilting machinery.

An additional object of the present invention is to provide a method for a user to receive a signal on a mobile device at a remote location

These and other objects of the present will be made clearer with references to the following detailed description and accompanying drawings.

The following are some of the advantages attributed to the method of the present invention:

1. The sewing machine according to the method of this invention can be utilized as desired. Hence, even when the user is located remotely from the sewing machine, the sewing machine can be utilized.

2. Due to the feedback signal provided by the sewing machine to the mobile device, a mobile device user can control the activity of the motor unit remotely.

3. The sewing machine according to the method of this invention can be initiated, controlled, and stopped by a user who is not located at or near the sewing machine. The user needs to have access to a wireless network and can be located at any location desired.

4. The security code portion of the initial signal can be set up by user, thereby resulting in flexibility and convenience in use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

### BRIEF DESCRIPTION OF THE DRAWINGS

FIG. 1 is an illustration showing a front perspective view of one embodiment of the present invention.

FIG. 2 is a block diagram of the process for effecting information transfer from user to sewing machine motor.

FIG. 3 is a block diagram of the process for effecting information transfer from user to transmittal unit.

FIG. 4 is a diagram of the process for effecting information transfer from wireless network to processing unit.

FIG. 5 shows a flow chart to illustrate how the sewing machine is initialized in accordance with the method of the preferred embodiment.

FIG. 6 is a flow diagram of the process from the motor unit performing stitching function to display signal on mobile phone.

### DETAILED DESCRIPTION OF THE PREFERRED EMBODIMENTS

The following presents a detailed description of a preferred embodiment, as well as some alternative embodiments of the present invention. However, it should be apparent to one skilled in the art that the described embodiment may be modified in form and content to be optimized for a wide variety of situations.

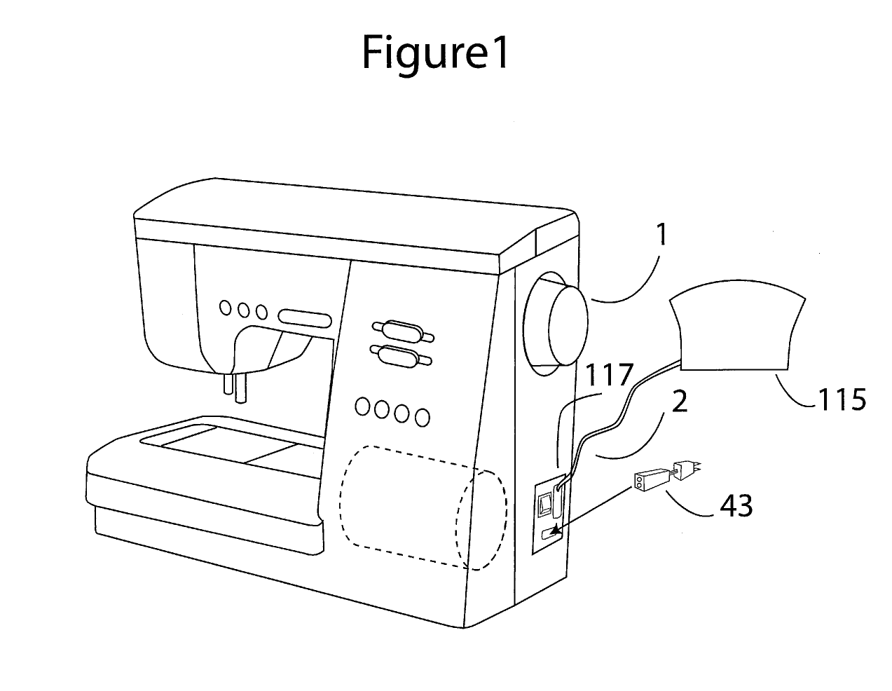

FIG. 1 illustrates a sewing machine that is configured to implement the preferred embodiment of a wireless control method according to the present invention. The sewing machine includes a main housing unit 1, a motor unit 118, disposed in the main housing 1, a wireless receiver device 115 connected by a wire cable connection 2, allowing direct communication between the main housing 1 and wireless receiver device 115.

A switch 117 makes and breaks electrical connection between the motor unit 118 and the wireless receiver device 115 when the wireless receiver device 115 is connected to the main housing 1.

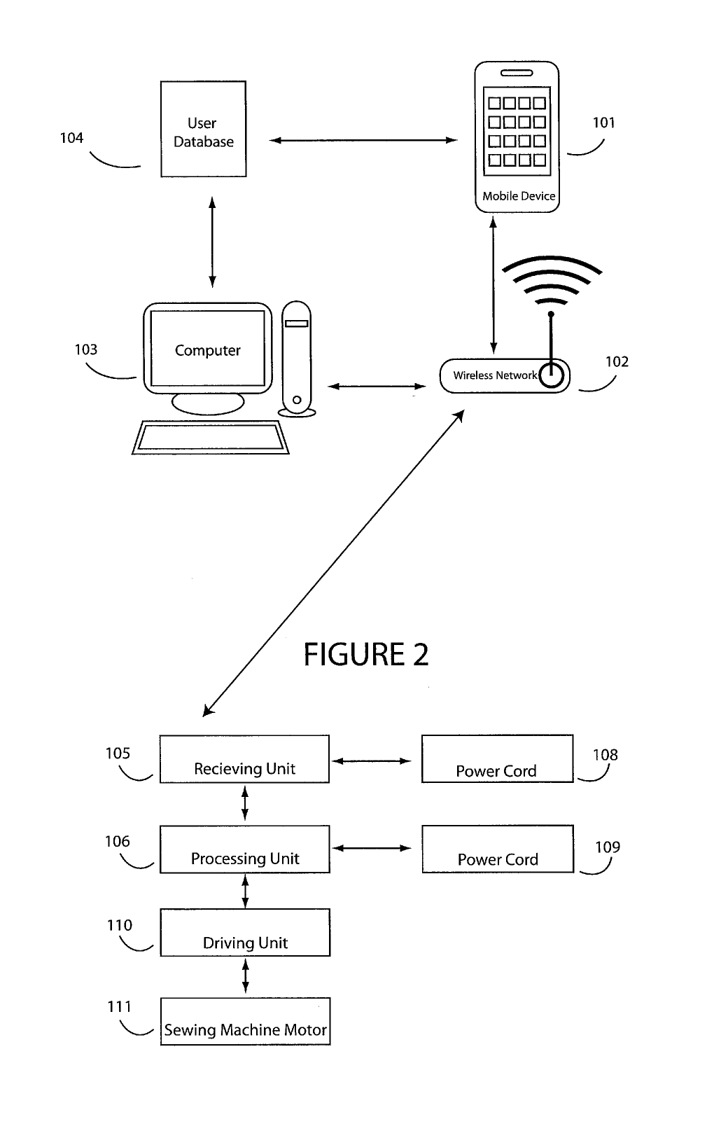

FIG. 2 shows the system diagram depicting the setup of the preferred embodiment of the present invention. To function, the system utilize mobile device 101, wireless network 102, user database 104, receiving unit 105, sewing machine processing unit 106, sewing machine 107, power cord to the receiving unit 108, power cord to the sewing machine 109, driving unit 110, and sewing machine motor 111. Mobile device 101 may be any device capable of transmitting data over wireless network 102 such as a cell phone, a camera phone, a personal digital assistant, a web camera attached to a computer, a computer 103, etc.

Patterns are initially transmitted to mobile device 101, from user database 104, preferably a design patter or other similar sewing patter. It should be apparent to one skilled in the art that database 104 may transmit to a mobile device 101 or computer 103 a menu of patters to select. A user of mobile device 101 can utilize a cellular phone application, or any downloadable program, which allows communication between a mobile device and a specific user database to select a patter. A cellular phone application is downloaded from user database 104 to mobile device 101 initially. After the phone application is downloaded from user database 104, the user of the mobile device may access a multitude of potential sewing patters. A user of a mobile device will select a pattern from the phone application on the mobile device 101.

Wireless network 102 may be any network capable of transmitting information wirelessly between mobile device 101 and receiving unit 105. For example, the wireless network could be cellular network, satellite network, Bluetooth network, Wi-Fi network, etc.

Receiving unit 105 is equipped with a device to receive and transmit wireless signals. Receiving unit 105 is a standard device, which stores users' identification numbers and is capable of being modified and updated in real-time. The receiving unit 105 has a switch power cord 108.

The sewing machine 106 is configured to implement the preferred embodiment of a wireless control method according to the present invention. The sewing machine includes a motor unit 111, a switch power cord 110.

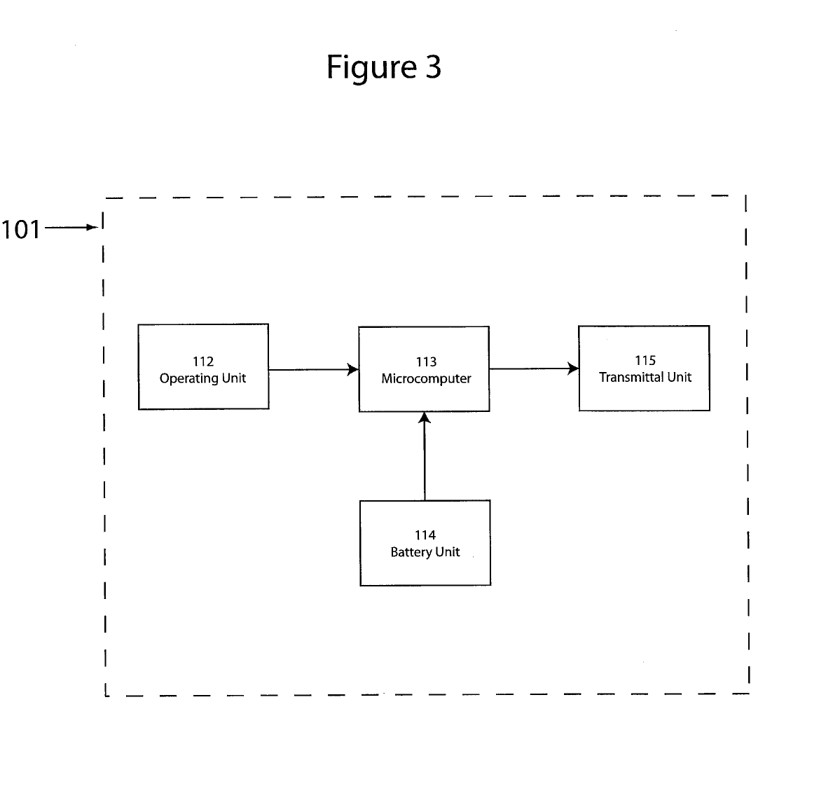

Referring to FIG. 3, the mobile device 101 includes an operating unit 112, a microcomputer 113, a transmitter unit 115, and a battery unit 114.

The operating unit 112 is operable so as to allow a user to select a visual pattern to be stitched. The microcomputer 113 is coupled to the operating unit 112 for receiving the signal there from, and outputs a signal corresponding to the signal from the operating unit 112. The transmitter unit 115 is coupled to the microcomputer 113. In this embodiment a wireless signal is used to transmit the control signals.

The battery unit 114, is coupled to the microcomputer 113, and supplies electric power to the microcomputer 113.

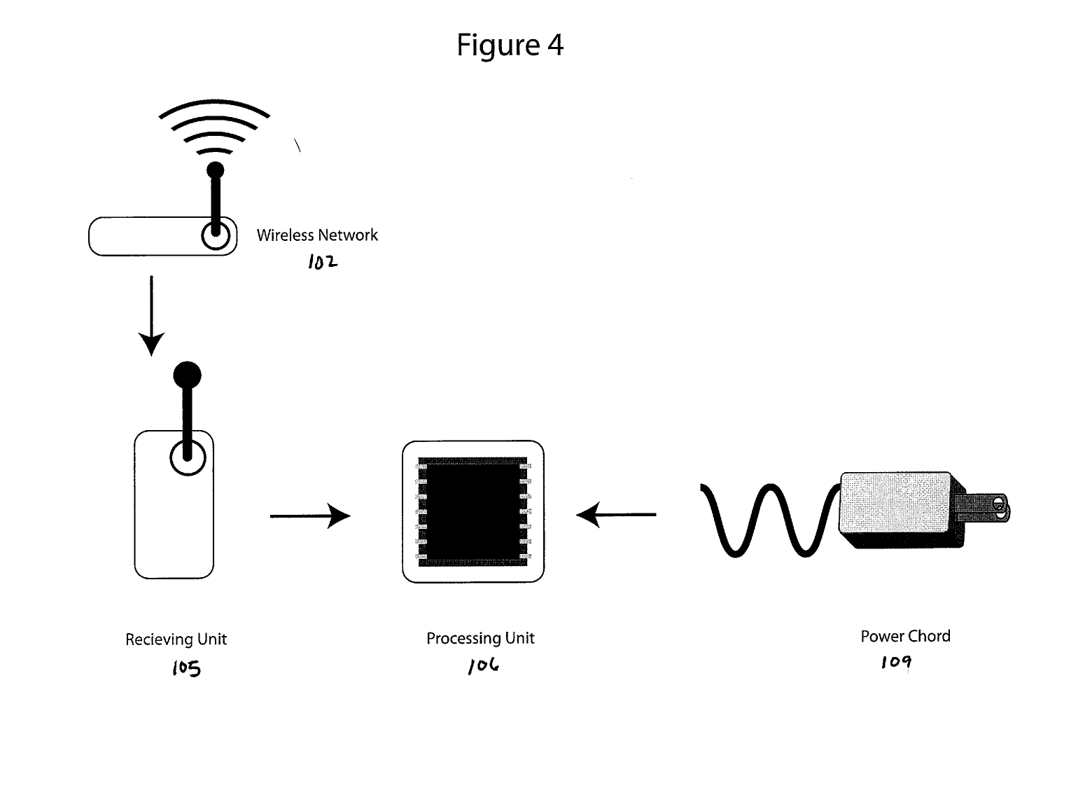

Referring to FIG. 4, the receiving device 115, includes a receiver unit 105, a processing Unit 106, a driving unit 110, and a press button 116. The receiver unit 105 receives the signals transmitted from the wireless network 102.

The processing unit 106 is connected to the receiver unit 105 for processing the signals received by the receiver unit 105 in accordance with a proprietary computer program associated with the method of the preferred embodiment.

The press button 116 is provided on the housing 107, is coupled to the processing unit 106, and is manually operable for setting up the processing unit 106.

The driving unit 110 is connected to the processing unit 106 and the switch 117, and is controlled by the processing unit 106 in accordance with the signals received by the receiver unit 105 so as to general corresponding motor control output. The Motor 118 is connected to the switch 117 and receives the motor control output.

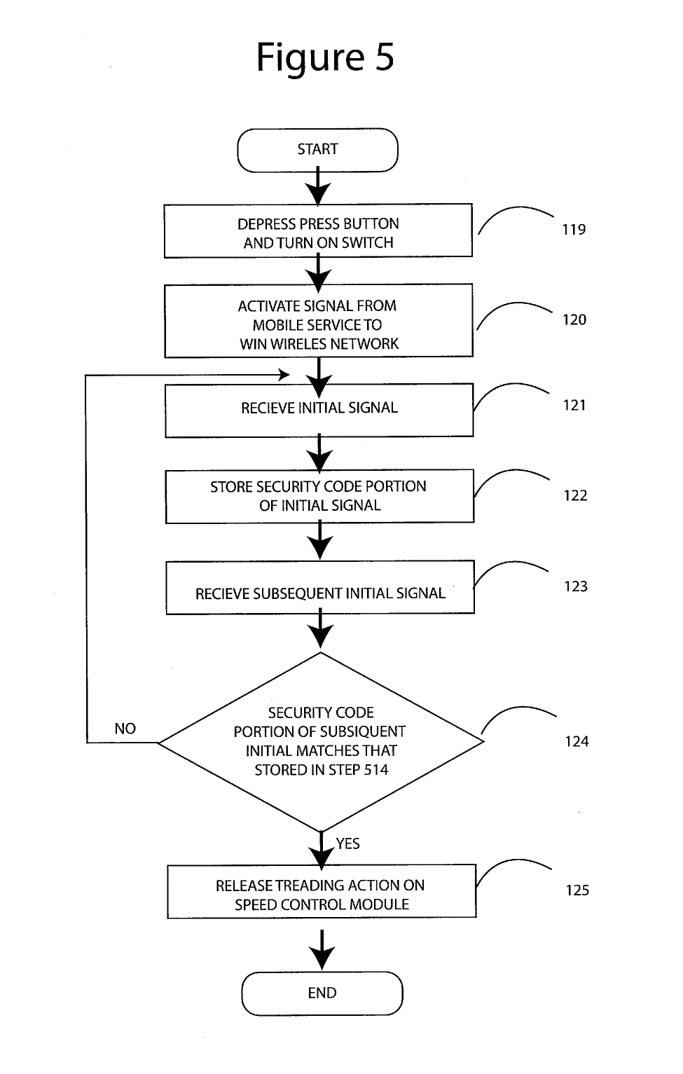

Referring to FIG. 5, there is shown a flow chart to illustrate how the sewing machine is initialized in accordance with the method of the preferred embodiment.

In step 119, the press button 116 of the receiver device 115 is depressed, and the switch 117 is turned on such that the sewing machine is set up to an initialized mode.

In step 120 the operating unit 112 of the mobile device 101 is activated to send a signal via the wireless network 102 and continuously transmit a control signal serving as an initial signal to the wireless receiver unit 105 in response to the signal of the mobile device 101. The initial signal includes a preset security code portion that had been stored in the microcomputer 113 prior to the delivery in this embodiment.

In step 121, the receiving unit 105 of the wireless receiver is configured to receive the initial signal transmitted initially from the wireless network 102.

In step 122, the processing unit 106 of the receiver device 115 is configured to store the security code portion of the initial signal initially received by the receiving unit 105 in step 121 in a predetermined memory of the processing unit 106.

In step 123, the receiving unit 105 of the receiver device 115 is configured to verify whether the security code portion of the initial signal subsequently received by the receiver unit 105 in step 122 matches the stored in step 121. When the match is not detected, steps 120, 121, and 122 are repeated.

In step 124, when a match is detected, initialization of the sewing machine is completed, and the wireless receiver device 115 is configured to provide a signal to the motor unit 118.

In step 125, the motor unit is initiated to stitch a pattern according to the signal provided initially by the mobile device 101.

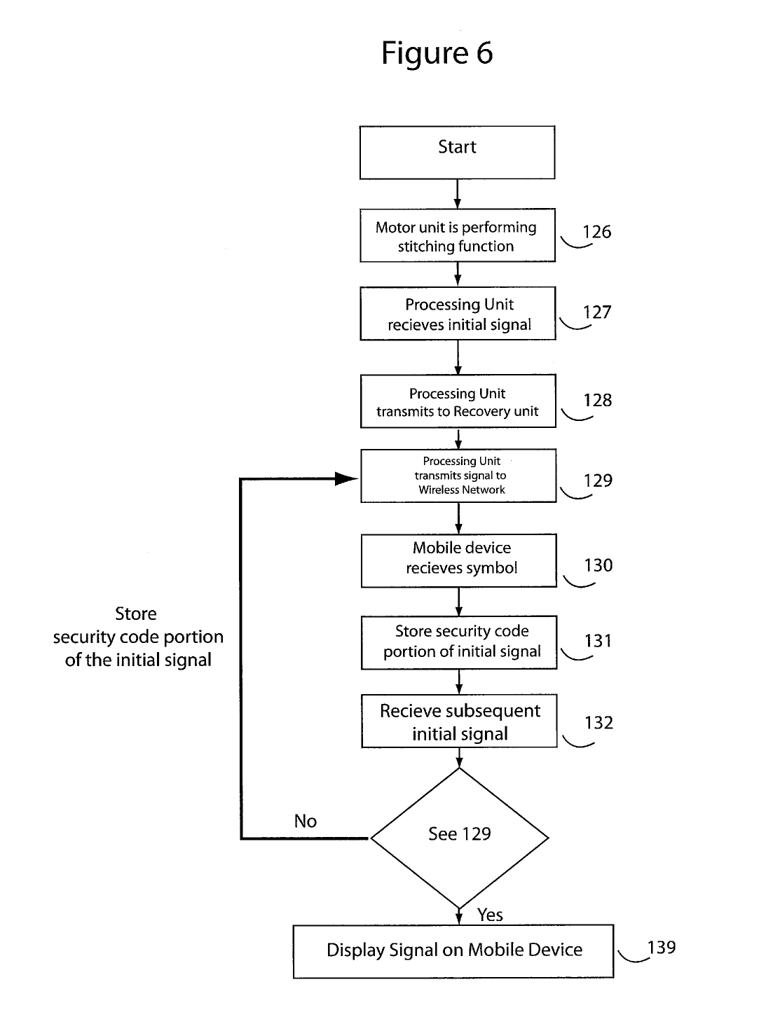

Referring to FIG. 6, there is shown a flow chart to illustrate how the mobile device receives a feedback signal from the sewing machine on the status and progress of the motor unit 118. The feedback signal will include information on status of progress, percent competed, speed of the motor, etc. This feedback signal is sent on a continuous basis to the mobile device 101 so the mobile device 101 user will be aware of the status of the sewing. Further, with this knowledge, the mobile device user 101 can elect to continue the progress of sewing or stop the motor unit 118 as described in providing the selected signal following FIG. 5.

In step 126 the motor unit 118 is either active or inactive. In step 127 the processing unit 106 receives a signal from the motor unit 118. This signal includes status or parameters of function including speed of the motor, duration of sewing, percent completion, and like information one skilled in the art would need to utilize a sewing machine. In step 128 the processing unit 106 sends a signal to the receiving unit 105. The receiving unit 105 has the duel functionality of receiving and transmitting signals to a wireless network 102. In step 129 the receiving unit 105 transmits a signal to the wireless network 102.

In step 130 the mobile device 101 receives the initial signal via the wireless network 102 transmitted from the receiving unit 105. In step 131, the mobile device 101 has a stored security code portion of the initial signal. In step 132 the mobile device 101 receives the subsequent initial signal. In step 133, the mobile device 101 verifies whether the security code portion of the initial signal subsequently received by the mobile device 101 matches that stored in step 131. When a match is not detected, steps 130, 131, and 132 are repeated.

In step 134, when a match is detected, the mobile device 101 processes the initial and subsequent signal. This signal is thereafter displayed on the mobile device 101 for the user.

I claim:

1. A method of wirelessly controlling a sewing machine, the sewing machine including a main housing, a motor unit disposed in the main housing, a wireless receiver unit connected on the main housing, and a wireless mobile device separate from the main hosing and operable so as to enable wireless transmission of signals to the wireless receiver unit in response to a signal from the wireless mobile device transmitted by wireless network, and said method comprising the steps of:
Selection of a control signal by a user utilizing a mobile device;
operation of the mobile device for transmitting wirelessly an initial signal to the wireless receiver unit, the initial signal including a present security code portion;
the wireless receiver unit to receive the initial signal from the mobile device and to store the security code portion of the received initial signal therein;
operation of the mobile device for transmitting wirelessly an incoming control signal to the wireless receiver unit, and enabling the wireless receiver unit to receive the incoming control signal from the mobile device, the incoming control signal including an identification code portion and a speed control portion;
configuring the wireless receiver unit to verify whether the identification code portion of the received inkling control signal matches the security code portion stored therein;
when a match is detected, controlling operation of the motor unit in accordance with the speed control code portion of the incoming control signal received by the wireless receiving unit;
operation of the motor unit to send a feedback message for transmitting wirelessly an outgoing control signal to the wireless receiver unit, and enabling the wireless receiver unit to transmit the outgoing control signal to the mobile device, the outgoing control signal including an identification code portion and a speed and status control portion;
the wireless receiver unit to transmit the initial signal to the mobile device and to transmit the security code portion of the outgoing initial signal therein;
enabling the mobile device to receive of a control feedback signal;
operation of the mobile device for receiving wirelessly an initial signal from the wireless receiver unit, the initial signal including a present security code portion; and
display of a control signal sent by a user utilizing a mobile device.

2. The method as claimed in claim 1, further comprising the step of enabling the wireless receiving unit to operate in a sleep mode when the wireless receiving unit has remained idle for a predetermined time period.

3. The method as claimed in claim 1, further comprising the step of selection of a stitching pattern, control signal including a signal to stop the motor unit, commence the motor unit, changing the speed of the motor unit, and stop the motor unit.

4. The method as claimed in claim 1 further comprising the feedback signal to include status of completion of project, speed of motor unit, problems related to the completion of the selected pattern.

5. The method as claimed in claim 4 further comprising the problems related to the completion as motor not functioning properly, electrical, mechanical, and stitching malfunctions.
